(19) United States
(12) Patent Application Publication
(10) Pub. No.: US 2012/0155406 A1
(43) Pub. Date: Jun. 21, 2012

(54) METHOD OF TRANSMITTING DATA IN MACHINE TYPE COMMUNICATION DEVICE AND MOBILE COMMUNICATION SYSTEM USING THE SAME

(75) Inventors: Kyung Sook KIM, Daejeon (KR); Jae Sheung SHIN, Daejeon (KR); Hyun Seo PARK, Daejeon (KR)

(73) Assignee: Electronics and Telecommunications Research Institute, Daejeon (KR)

(21) Appl. No.: 13/331,876

(22) Filed: Dec. 20, 2011

(30) Foreign Application Priority Data
Dec. 21, 2010 (KR) 10-2010-0132001

(51) Int. Cl. H04W 72/04

(52) U.S. Cl. 370/329

(57) ABSTRACT

Provided is a method of transmitting data in at least one machine type communication (MTC) device belonging to an MTC group identified by a unique identity according to application features. The method includes setting, by at least one MTC device belonging to the MTC group, unique transmission latency; waiting, by the MTC device, for the set transmission latency and then receiving information on uplink resources allocated to each MTC group identity from a base station; and transmitting, by the MTC device, uplink data using the allocated uplink resources.

### CLAIM FOR PRIORITY

This application claims priority to Korean Patent Application No. 10-2010-0132001 filed on Dec. 21, 2010 in the Korean Intellectual Property Office (KIPO), the entire contents of which are hereby incorporated by reference.

### BACKGROUND

1. Technical Field

Example embodiments of the present invention relate in general to a method of efficiently transmitting data in a machine type communication (MTC) device of an MTC system, and a mobile communication system using the same.

2. Related Art

MTC or machine-to-machine communication (M2M) is a form of data communication which involves one or more entities that do not necessarily need human interaction. A service optimized for MTC differs from a service optimized for H2H communication. In comparison with a current mobile network communication service, the MTC service can be characterized by a) several market scenarios, b) data communications, c) lower cost and less effort, d) a potentially larger number of communicating terminals, e) a wider service area, and f) very low traffic per terminal.

MTC may appear in a variety of service forms, such as smart metering, tracking and tracing, remote maintenance and control, eHealth and the like.

In recent 3GPP, an MTC standardization task for intelligent communication between a person and a machine and between a machine and a machine is being conducted. A number of MTC devices are deployed and managed for various MTC applications having smart metering and remote control as primary functions.

In a 3GPP LTE system, an MTC device or a general terminal must be treated as one terminal (user equipment) and individually registered in an LTE network. Deployment of a number of MTC devices causes scheduling competition for channel allocation, exhaustion of wireless resources, overload due to signal generation, and the like, which negatively affects existing general terminals.

In the 3GPP LTE system, if there are no allocated uplink resources at a data transmission request time, a terminal transmits a scheduling request to a base station to request allocation of uplink resources. If a UL grant is received as a response to the scheduling request, the terminal performs uplink data transmission. If the terminal does not receive the UL grant within a predefined time after transmitting the scheduling request, the terminal re-attempts the scheduling request through a predefined number of maximum scheduling request transmissions.

According to features of the MTC service, a number of MTC devices related to an application characterized by periodic data transmission may simultaneously make a data transmission request. This rapidly increases overload of an access network. Scheduling request resources available at the same time and allocable uplink channel resources are limited, which may be a problem when performing applications in the MTC device and also providing services for general mobile terminals.

### SUMMARY

Accordingly, Example embodiments of the present invention are provided to substantially obviate one or more problems due to limitations and disadvantages of the related art.

Example embodiments of the present invention provide a method of transmitting data in a machine type communication (MTC) device that resolves overload of the access network caused by concurrent data transmissions of the MTC devices and provides smooth service to the MTC device and the general mobile terminal by grouping MTC devices according to application features in an MTC system and distributing data transmission time among the MTC devices constituting the same group, and a mobile communication system using the same.

In some example embodiments, a method of transmitting data in at least one MTC device belonging to an MTC group identified by a unique identity according to application features includes: setting, by at least one MTC device belonging to the MTC group, unique transmission latency; waiting, by the MTC device, for the set transmission latency and then receiving information on uplink resources allocated to each MTC group identity from a base station; and transmitting, by the MTC device, uplink data using the allocated uplink resources.

The transmission latency uniquely set for each MTC device may be selected and set with a random variable for each MTC device.

The transmission latency uniquely set for each MTC device may be selected and set with an offset differently set for each MTC device.

The MTC group may include at least one MTC device having the same application execution period and start and end times

The MTC group identity may be an MTC group cell radio network temporary identity (C-RNTI) differently set for each MTC group.

The information on uplink resources allocated to each MTC group identity may be transmitted to the MTC device via a physical downlink control channel by the base station.

The uplink data transmitted by the MTC device may include C-RNTI information of the MTC device.

In other example embodiments, a mobile communication system for providing MTC (MTC) service includes: a base station configured to assign a unique identity to each of MTC groups classified according to application features, allocate uplink resources to each MTC group identity, and transmits information on the uplink resources allocated to each MTC group identity; and at least one MTC device belonging to one MTC group, the MTC device being configured to set a unique transmission latency, wait for the set latency, receive information on the uplink resources allocated to each MTC group identity from the base station, and transmit data to the base station using the allocated uplink resources.

In still other example embodiments, a base station apparatus communicating with at least one MTC device assigns a unique identity to each of MTC groups classified according to application features, allocates uplink resources to each MTC group identity, and transmits information on the uplink resources allocated to each MTC group identity via a physical downlink control channel (PDCCH).

In still other example embodiments, an MTC device communicating with a base station in a mobile communication network providing an MTC service sets a transmission latency, waits for the set latency, receives information on uplink resources allocated to each MTC group identity from a base station, and transmits uplink data using the allocated uplink resources, and the transmission latency uniquely set for at least one MTC device belonging to the same MTC group is selected with a random variable for each MTC device or with an offset differently set from at least another MTC device belonging to the same MTC group.

According to the present invention, MTC devices are classified into MTC groups according to application features in the MTC system, and the MTC devices in the MTC group transmit data using physical uplink shared resources allocated to the MTC group C-RNTI. In this case, the MTC devices in the MTC group distribute times when data is transmitted using the resources allocated to the MTC group identity, randomly or according to a fixed variable set for each MTC device, thereby resolving overload of an access network caused by concurrent data transmissions of the MTC devices and providing smooth service to the MTC devices and general mobile terminals.

### BRIEF DESCRIPTION OF DRAWINGS

Example embodiments of the present invention will become more apparent by describing in detail example embodiments of the present invention with reference to the accompanying drawings, in which:

FIG. 1 illustrates a wireless communication network providing a machine type communication service to which the present invention is applied;

FIG. 2 shows an uplink data transmission operation through a scheduling request from a general terminal;

FIG. 3 illustrates an operation flow between an MTC device and a base station when the MTC device randomly determines a data transmission time and transmits data according to an example embodiment of the present invention; and

FIG. 4 illustrates an operation flow between an MTC device and a base station when the MTC device determines a data transmission time in a fixed manner and transmits data according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A “terminal” used in this disclosure may be referred to as mobile station (MS), user equipment (UE), user terminal (UT), wireless terminal, access terminal (AT), terminal, subscriber unit, subscriber station (SS), wireless device, wireless communication device, wireless transmit/receive unit (WTRU), mobile node, mobile or the like. Various example embodiments of the terminal may include a cellular telephone, a smart phone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storage and playback appliance having a wireless communication function, an Internet appliance having wireless Internet accessing and browsing functions, and a portable unit or terminal having a combination of such functions, but are not limited thereto.

A “base station” used in this disclosure generally refers to a stationary point that communicates with a terminal. The base station may be referred to as node-B, eNode-B, a base transceiver system (BTS), an access point, or the like.

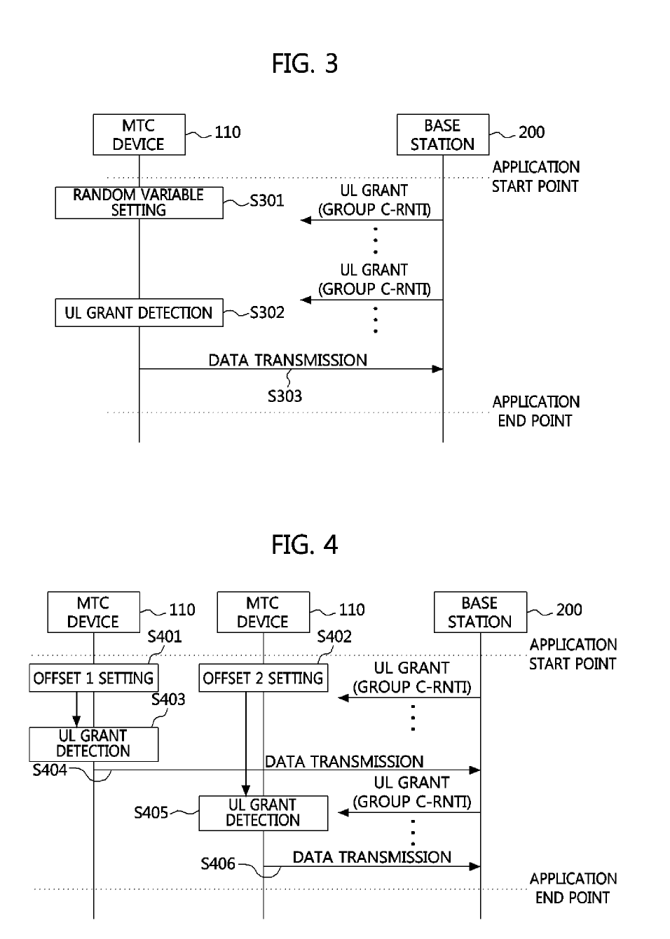

An example embodiment of the present invention is characterized in that machine type communication (MTC) devices are classified into MTC groups according to application features in an MTC system and a base station allocates physical uplink shared resources for each MTC group identity. Further, an example embodiment of the present invention is characterized in that the MTC device transmits data using uplink shared resources allocated to an MTC group identity to which the MTC device belongs. In this case, a method of distributing times when the respective MTC devices in the MTC group transmit data using the resources allocated to the MTC group identity may be classified into a method of randomly distributing the times and a method of distributing the times in a fixed manner. The respective methods will be described in greater detail with reference to FIGS. 3 and 4, respectively.

The MTC group according to an example embodiment of the present invention may include at least one MTC device having the same application execution period and start and end times. Each MTC group is identified by a unique MTC group C-RNTI.

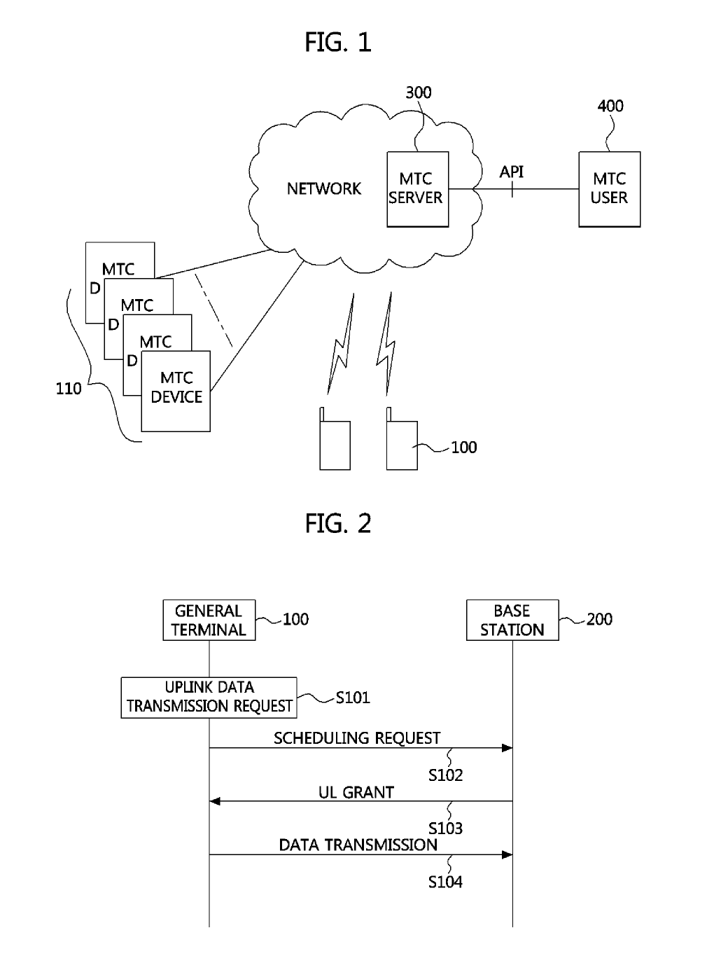

FIG. 1 illustrates a wireless communication network providing an MTC service to which the present invention is applied.

In the 3GPP 22.368 standard, network architecture of an MTC system for supporting MTC involving at least one MTC terminal is defined as shown in FIG. 1.

As shown in FIG. 1, the wireless communication network providing an MTC service includes an MTC server 300 for providing the MTC service, MTC devices 110, and an MTC user 400, in addition to an existing wireless communication network including general terminals 100.

The MTC device 110 is a terminal (UE) having an MTC communication function of communicating with the MTC server 300 and the other MTC devices over a network.

The MTC server 300 communicates with a PLMN, and communicates with the MTC device 110 via the PLMN. The MTC server 300 also has an interface accessible to the MTC user, and provides services for the MTC user 400. The MTC user 400 uses the services provided by the MTC server 300.

In the architecture of FIG. 1, the MTC server 300 is controlled by a network operator, which provides an application programming interface (API) to the MTC server, and the MTC user 400 accesses the MTC server of the network operator via the API.

Meanwhile, the MTC server is included in a network operator domain in FIG. 1. Alternatively, the MTC server is not located in the network operator domain, but may be located outside the network operator domain. In this case, the MTC server is not controlled by the network operator.

Further, MTC applications may be largely classified into applications requiring periodic operation of the MTC device and applications requiring aperiodic operation of the MTC device. If the periodic operation is required, the MTC device transmits data to the MTC server at a defined time in a previously defined period (e.g., every 5 minutes, every 30 minutes, or hourly).

FIG. 2 shows an uplink data transmission operation through a scheduling request from a general terminal.

If there are no allocated physical uplink shared resources (physical uplink shared channel; PUSCH) at a time when data transmission is required (S101), a general terminal 100 operating in a 3GPP LTE system transmits a scheduling request (SR) to a base station 200 to request uplink resource allocation (S102). If the terminal receives a UL grant as a response to the SR from the base station (S103), the terminal performs uplink data transmission (S104). If the terminal does not receive the UL grant within a previously set time after transmitting the SR, the terminal re-attempts the SR through a previously defined maximum number of SR transmissions.

Similarly, if there are no allocated physical uplink shared resources when an MTC device makes a periodic data transmission request, the MTC device transmits an SR to the base station as shown in FIG. 2, and performs data transmission after receiving a UL grant as a response to the SR.

Accordingly, if a number of MTC devices related to an application having a feature of periodic data transmission simultaneously request data transmission, overload of an access network rapidly increases. SR resources and physical uplink shared channel resources available at the same time are limited, which may be a problem when performing an application in the MTC device and also providing services for general mobile terminals.

FIG. 3 illustrates an operation flow between an MTC device and a base station when the MTC device randomly determines a data transmission time and transmits data according to an example embodiment of the present invention.

That is, FIG. 3 illustrates a case of randomly distributing times when respective MTC devices in an MTC group transmit data using resources allocated to the MTC group identity according to an example embodiment of the present invention.

A base station 200 allocates physical uplink shared resources within the available resources to MTC group cell radio network temporary identity (C-RNTI) at an arbitrary time from an application start point to an application end point of the MTC group and transmits resource allocation information (UL Grant) via a physical downlink control channel (PDCCH).

If the method of randomly determining a data transmission time as shown in FIG. 3 is used, at least one MTC device 100 belonging to an MTC group creates a random variable between the application start point and the application end point (S301).

The MTC device waits for the set random variable, detects information (UL Grant) of physical uplink shared resource allocation to the MTC group C-RNTI in the PDCCH transmitted by the base station (S302) and performs data transmission via allocated physical uplink shared resources (PUSCH) (S303). Here, according to an example embodiment of the present invention, uplink data transmitted by the MTC device may further include C-RNTI information of the MTC device.

That is, the respective MTC devices in the MTC group select a random variable and determine a data transmission time according to the random variable, thereby distributing transmission times among a number of MTC devices. With the configuration according to the example embodiment of the present invention shown in FIG. 3, it is possible to resolve overload of an access network caused by concurrent data transmissions of the MTC devices and provide smooth service to MTC devices and general mobile terminals.

FIG. 4 illustrates an operation flow between an MTC device and a base station when the MTC device determines a data transmission time in a fixed manner and transmits data according to an example embodiment of the present invention.

That is, FIG. 4 illustrates a case of distributing, in a fixed manner, times when respective MTC devices in an MTC group transmit data using resources allocated to an MTC group identity according to another example embodiment of the present invention.

In this case, the respective MTC devices in the MTC group set different unique offset information. Each MTC device in the MTC group attempts to detect UL grant allocation information transmitted to MTC group C-RNTI in a PDCCH channel from a subframe after its unique offset time elapses from an application start point. When the MTC device receives information (UL grant) of physical uplink shared resource allocation to the MTC group C-RNTI, the MTC device performs data transmission using allocated resources. In this case, uplink data transmitted by the MTC device may include C-RNTI information of the MTC device.

An example of this case will be described with reference to FIG. 4. Offset 1 and offset 2 are set for a first MTC device 110-1 and a second MTC device 110-2, respectively (S401 and S402). The first MTC device 110-1 detects information (UL grant) of physical uplink shared resource allocation to the MTC group C-RNTI in a PDCCH channel transmitted by a base station after a time corresponding to offset 1 elapses (S403), and performs uplink data transmission using the allocated resources (S404).

Here, according to an example embodiment of the present invention, the uplink data transmitted by the MTC device may further include C-RNTI information of the MTC device.

Further, the second MTC device 110-2 detects information (UL grant) of physical uplink shared resource allocation to the MTC group C-RNTI in the PDCCH channel transmitted by the base station after a time corresponding to offset 2 elapses (S405) and performs uplink data transmission using the detected allocation resources (S406).

In summary, according to the example embodiment of the present invention shown in

FIG. 4, the respective MTC devices in the MTC group set different offset information and distribute data transmission times according to the different offset information. Consequently, it is possible to resolve overload of an access network caused by concurrent data transmissions of the MTC devices and provide smooth services to the MTC devices and general mobile terminals.

According to the example embodiment shown in FIG. 4, with the method of distributing the data transmission times according to the offsets differently set among MTC devices in the MTC group, it is possible to more efficiently avoid transmission collision among the MTC devices that desire to transmit data using the physical uplink shared resources allocated to the MTC group C-RNTI in the MTC group, compared to the method in which MTC devices in the MTC group randomly distribute data transmission times according to the example embodiment shown in FIG. 3.

While the example embodiments of the present invention and their advantages have been described in detail, it should be understood that various changes, substitutions and alterations may be made herein without departing from the scope of the invention.

What is claimed is:

1. A method of transmitting data in at least one machine type communication (MTC) device belonging to an MTC group, the MTC group being identified by a unique identity according to application features, the method comprising:
setting, by each MTC device, unique transmission latency;
waiting for the set transmission latency and receiving information on uplink resources allocated to each MTC group identity from a base station; and
transmitting uplink data using the allocated uplink resources.

2. The method of claim 1, wherein the transmission latency uniquely set for each MTC device is selected and set with a random variable for each MTC device.

3. The method of claim 1, wherein the transmission latency uniquely set for each MTC device is selected and set with an offset differently set for each MTC device.

4. The method of claim 1, wherein the MTC group includes at least one MTC device having the same application execution period and start and end points of time.

5. The method of claim 1, wherein the MTC group identity is an MTC group cell radio network temporary identity (C-RNTI) differently set for each MTC group.

6. The method of claim 1, wherein the information on uplink resources allocated to each MTC group identity is transmitted to the MTC device via a downlink control channel by the base station.

7. The method of claim 1, wherein the uplink data transmitted by the MTC device includes C-RNTI information of the MTC device.

8. A mobile communication system for providing machine type communication (MTC) service, the mobile communication system comprising:
a base station configured to assign a unique identity to each of MTC groups classified according to application features, allocate uplink resources to each MTC group identity, and transmits information on the uplink resources allocated to each MTC group identity; and
at least one MTC device belonging to one MTC group, the MTC device being configured to set a unique transmission latency, wait for the set latency, receive information on the uplink resources allocated to each MTC group identity from the base station, and transmit data to the base station using the allocated uplink resources.

9. The mobile communication system of claim 8, wherein the transmission latency uniquely set for each MTC device is selected and set with a random variable for each MTC device.

10. The mobile communication system of claim 8, wherein the transmission latency uniquely set for each MTC device is selected and set with an offset differently set for each MTC device.

11. The mobile communication system of claim 8, wherein the MTC group includes at least one MTC device having the same application execution period and start and end points of time.

12. A base station communicating with at least one machine type communication (MTC) device, wherein the base station assigns a unique identity to each of MTC groups classified according to application features, allocates uplink resources to each MTC group identity, and transmits information on the uplink resources allocated to each MTC group identity via a physical downlink control channel (PDCCH).

13. The base station apparatus of claim 12, wherein the MTC group identity is an MTC group C-RNTI differently set for each MTC group.

14. The base station apparatus of claim 12, wherein the MTC group includes at least one MTC device having same application execution period and start and end points of time.

15. A machine type communication (MTC) device communicating with a base station in a mobile communication network providing an MTC service, wherein:
the MTC device sets a transmission latency, waits for the set latency, receives information on uplink resources allocated to each MTC group identity from a base station, and transmits uplink data using the allocated uplink resources, and
the transmission latency uniquely set for at least one MTC device belonging to the same MTC group is selected with a random variable for each MTC device or with an offset differently set from at least another MTC device belonging to the same MTC group.

16. The MTC device of claim 15, wherein the uplink data transmitted by the MTC device includes C-RNTI information of the MTC device.
